(19) United States
(12) Patent Application Publication
(10) Pub. No.: US 2008/0228336 A1
(43) Pub. Date: Sep. 18, 2008

(54) METHOD AND MEANS FOR SELF CALIBRATING A VALID OPERATING RANGE

(75) Inventor: Brian E. Spranger, Crystal, MN (US)

Correspondence Address: ZARLEY LAW FIRM P.L.C., CAPITAL SQUARE, 400 LOCUST, SUITE 200, DES MOINES, IA, 50309-2350, US

(73) Assignee: SAUER-DANFOSS INC., Ames, IA (US)

(21) Appl. No.: 11/685,795

(22) Filed: Mar. 14, 2007

(51) Int. Cl. G06F 7/00

(52) U.S. Cl. 701/29

(57) ABSTRACT

A method of calibrating a valid operating range. The method includes loading a default calibration limit and then monitoring an input for new calibration limits provided by an input device. An algorithm then detects if the new calibration limits provide a fault and if not the algorithm rescales the output based upon the new calibration limits to increase the valid operating range.

### BACKGROUND OF THE INVENTION

This disclosure relates to a method and means for a calibration process. More specifically, this disclosure relates to a precise control for a mini joystick or the like.

When a device has replaceable parts that have inconsistent tolerances, electrical and mechanical calibration is needed. Often when replacing these parts the calibration process used is time consuming and inconvenient.

Thus, a principal object of the present invention is to provide an improved control system that is self calibrating.

Yet another object of the present invention is to provide a method of calibration that eliminates the need for complex calibration processes.

These and other objects, features, or advantages of the present invention will become apparent from the specification and claims.

### BRIEF SUMMARY OF THE INVENTION

A method of calibrating a valid operating range. The steps include loading default calibration limits and then using an algorithm to monitor inputs for new calibration limits from an input device. Once the new calibration limits are received the algorithm detects if the new calibration limits provide a fault and if not the algorithm rescales an output based upon the new calibration limits to increase the valid operating range.

### BRIEF DESCRIPTION OF THE DRAWINGS

FIG. 1 is a schematic diagram of a control system for an operating device; and

FIG. 2 is a flow chart showing the functioning of an algorithm for calibrating a device.

### DETAILED DESCRIPTION OF THE PREFERRED EMBODIMENT

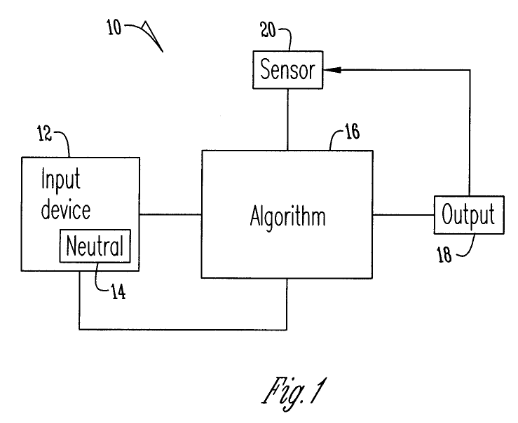

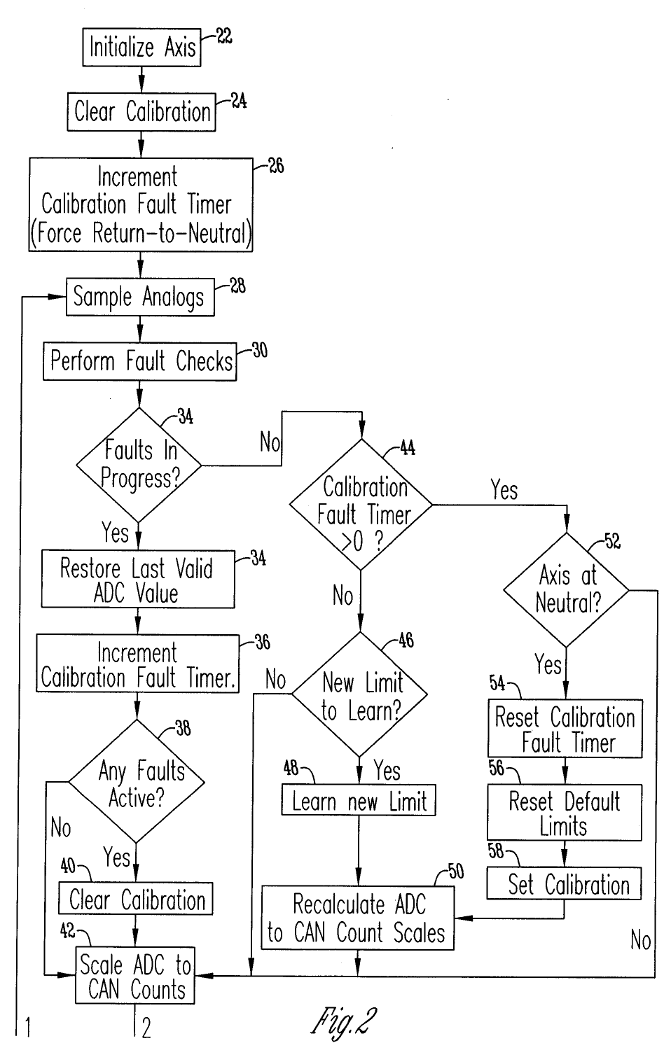

FIG. 1 shows a schematic diagram of a control system 10 for a device that requires calibration. In a preferred embodiment the control system 10 is for a tractor loader backhoe joystick wherein a replaceable mini joystick is provided. The control system 10 has an input device 12 with a neutral position 14 that provides an input to algorithm 16 that generates an output 18 and receives information from a sensor 20.

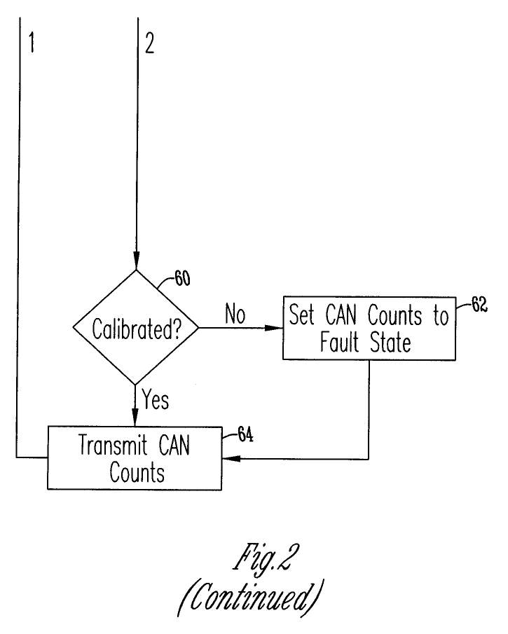

FIG. 2 shows a flow chart of algorithm 16. The process starts with step 22 wherein the algorithm initializes an axis. Then at step 24 the calibration is cleared such that default calibration limits are loaded. Then at step 26 an increment calibration fault timer is used to determine if the input device 12 needs to be returned to neutral. Thus, from this input sample analogs are provided at step 28 to provide output 18.

At step 30 a fault check is performed. First, the algorithm makes a decision 32 regarding whether faults are in progress. If faults are in progress at decision 32 the algorithm restores the last valid output at step 34. This information is then inputted into the increment calibration fault timer at block 36. At this time a decision is made at block 38 regarding whether faults are active. If there are faults active the calibration is cleared at block 40. If there are not faults active at decision block 38 or if the calibration is cleared at block 40, in either case the output is rescaled accordingly at block 42.

If at decision 32 regarding whether faults are in progress the algorithm determines that faults are not in progress, at that time a second decision 44 is made regarding whether the calibration fault timer is greater than zero. If not, a decision 46 is made regarding whether there is a new limit that needs to be learned. If not, this information is used to rescale the output at block 42; however, if a new limit needs to be learned then at block 48 the algorithm learns this new limit. At this time the algorithm recalculates and rescales the output at block 50 and such information is passed on to block 42.

If at the decision 44 the algorithm determines that the calibration fault timer is greater than zero then a decision 52 is made regarding whether the axis is at neutral. If the axis is not at neutral at step 52 this information is then used to rescale the output at step 42. However, if the axis is at neutral at decision 52 then the calibration fault timer is reset at step 54 which resets the default limits at block 56 and sets the calibration at block 58. At this time the output is recalculated and rescaled at block 50 and this information is passed on to block 42.

Once the resealing of the output occurs at block 42 the algorithm 16 makes a decision 60 regarding if the output is calibrated. If not, a fault state is present as seen at block 62 and if calculated at block 64 this output is transmitted back to the sample analogs at block 28. Thus, by using algorithm 16 the control system 10 can learn calibration ranges eliminating the need for exhaustive calibration procedures.

In operation, upon startup, the fault calibration limits are loaded. During operation the algorithm 16 monitors the inputs for new calibration limits to increase the scaled operating range. When a new valid limit is achieved, the algorithm determines or “learns” the value and rescales the outputs based on the new limits. If the algorithm 16 detects a fault the algorithm 16 retains the last valid output and disables learning until either the input returns within the valid range or the fault timer expires. If the fault timer expires a fault occurs and the output indicates a fault until the input 12 returns to the neutral position 14. Once the input 12 reaches the neutral position 14 the fault is cleared and the default calibration limits are reloaded.

If the fault timer does not expire the algorithm operates with its current set of learned values. However, once the input 12 reaches the neutral position 14 the default calibration limits are reloaded and the algorithm begins to monitor the inputs for new calibration limits. This is to ensure that an incorrect value has not been learned. One skilled in the art will understand that the calibration limits used for the algorithm can be based on voltages, currents, percentages, or the like. Though, in a preferred embodiment the calibration limits used for the algorithm are based upon voltages.

As an example of operation the algorithm output can be scaled to any output range such as, for example only, an output range from −1000 to 1000. Thus, when the calibration limits used for the algorithm are based on voltages the default minimum calibration voltage defines the lower limit where the sensor output reaches negative 1000 counts. The minimum calibration voltage is monitored by the algorithm 16 and once the algorithm 16 detects a voltage less than the current minimum calibration voltage, the algorithm 16 learns the new voltage. Then, the output 18 is rescaled to this newly learned voltage.

The default minimum neutral calibration voltage defines the limit where the sensor output reaches negative one count. This voltage is not monitored by the algorithm 16 and the minimum and maximum neutral calibration voltages define a neutral zone. Similarly, the default maximum neutral calibration voltage defines the limit where in the sensor output reaches one count. This voltage also is not monitored by the algorithm 16 as the minimum and maximum neutral calibration voltage is defined in the neutral zone.

In regard to the maximum calibration voltage, the default maximum calibration voltage defines the limit where the sensor output reaches 1000 counts. This maximum calibration voltage is monitored by the algorithm 16 and when the algorithm 16 detects a voltage greater than the current maximum calibration voltage it learns this new voltage. At this time the output is rescaled to this newly learned voltage.

The fault timer has a predetermined amount of time that the timer takes before the output goes to a fault condition. In one embodiment the predetermined amount of time is a number of milliseconds. Once a fault condition occurs at block 62 the input 12 is forced to return to neutral 14 before a valid output occurs. In an embodiment wherein voltage is being calibrated there can be multiple separate fault timers for voltage too high, voltage too low, and redundancy type conditions. Specifically, the fault timers are specified per the system and not per axis.

Thus, disclosed is a calibration method wherein a control system 10 uses an algorithm 16 to self calibrate. Specifically, by monitoring new inputs for new calibration limits a valid operating range can be increased by resealing the output. Additionally, the algorithm has provisions for determining faults within the system to minimize improper outputs. Thus, at the very least all of the stated objectives have been met.

It will be appreciated by those skilled in the art that other various modifications could be made to the device without the parting from the spirit in scope of this invention. All such modifications and changes fall within the scope of the claims and are intended to be covered thereby.

What is claimed is:

1. A method of calibrating a valid operating range steps comprising:
loading default calibration limits;
monitoring inputs for new calibration limits from an input;
detecting if the new calibration limits provide a fault; and
resealing outputs with an algorithm based upon the new calibration limits to increase the valid operating range.

2. The calibrating method of claim 1 further comprising the step of retaining a last valid output when a fault is detected.

3. The calibrating method of claim 1 wherein when a fault is detected for a predetermined amount of time a fault timer returns the input to a neutral position.

4. The calibrating method of claim 3 wherein when the input is returned to the neutral position the default calibration limits are reloaded.

5. The calibrating method of claim 1 wherein the new calibration limits are based upon voltages.

6. The calibrating method of claim 1 wherein the new calibration limits are based upon currents.

7. The calibrating method of claim 1 wherein the default calibration limits are for a joystick of a backhoe.
